(19) United States
(12) Patent Application Publication
(10) Pub. No.: US 2005/0177627 A1
(43) Pub. Date: Aug. 11, 2005

(54) Server for standby management in a network

(75) Inventors: Thomas Vollmer, Aachen (DE); Thomas Durbaum, Langerwehe (DE); Carsten Deppe, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/506,838

(22) PCT Filed: Mar. 3, 2003
(86) PCT No.: PCT/IB03/00874

(30) Foreign Application Priority Data
Mar. 12, 2002 (DE) 102 10 857.9

(51) Int. Cl. G06F 15/16

(52) U.S. Cl. 709/220; 709/203

(57) ABSTRACT

The invention relates to a method and a server (1) for implementation of central standby functions in an (in-home) network with devices (11-16) connected thereto. The standby server (1) contains a central processor (3), a mass memory (4) and interfaces (2, 5, 6) for the network connection. When one of the devices (11-16) is shut down, it sends corresponding information and where applicable data to the server (1) whereupon the latter takes over the standby functions for the device. In particular the server (1) can temporarily store data directed to the device as long as this is switched off, or pass on with time delay data to be transmitted by the device. Centralization of the standby functions in a special server reduces the energy consumption and improves the speed of data transmission.

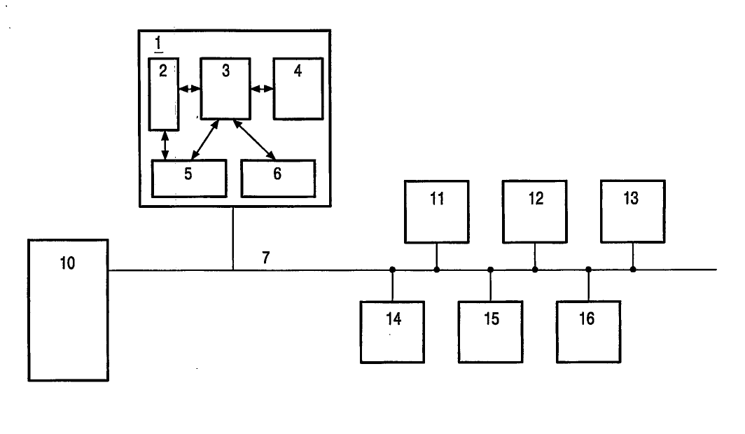

The invention relates to a method for management of availability of functions in a network of electronic devices by a server connected to a network. It also relates to a server for performance of such a method containing a central processor, a memory and at least one network interface.

Networked electronic devices are used increasingly in all areas of life. Where these concern the domestic area, the associated networks are known as in-home networks. Such an in-home network may contain televisions, radios, monitors, speakers, cameras, printers, scanners, PCs, telephone services, speech recognition, domestic appliances, security devices and the like. Many modern devices are supplied via the network or via their signal sources (antenna, cable network etc.) with additional information which increases the operating comfort, assists the user or controls automatic functions. In order to be able to utilize these signal sources, the devices are operated in “semi-standby” mode in which (only) the receiver stages and controller are active while the main functions of the device are switched off. Examples of devices with such standby functions are set-top boxes, TV Guide+USA, TIVO and programmed time-delayed downloads from the Internet to reduce charges and loading times. There is also a great trend towards increasing networking of devices, for example based on Internet technologies.

The disadvantage with the standby functions described of these devices is the fact that these have a certain power consumption which may, for the operation of several devices, add up to a considerable amount. In order not to reduce the power consumption of the devices used in a network, it is known in this respect from EP 0 978 780 A1 to monitor by means of a microcomputer the activity of devices such as a video monitor or computer and when inactivity is established, to give the device a command to switch to energy-saving mode. Where this energy-saving mode however consists of a complete shut-down of the device, the standby functions of the device are also lost.

In this context it is an object of the present invention to produce a method and a device for managing the availability of functions in a network of electronic devices, which reduce energy consumption without loss of functionality and comfort.

This object is achieved by a method with the features of claim 1 and a server with the features of claim 7. Advantageous embodiments are described in the dependent claims.

In the method according to the invention by means of a server connected to a network the availability of functions of electronic devices connected to the network is managed. The method is characterized in that certain functions of the devices are performed by the server when the devices themselves are switched off.

In the method therefore the devices need not maintain a minimum or standby mode in order to be able to perform certain standby functions. These standby functions are rather transferred to a central server and performed by this, so that the device concerned can itself be switched off completely and hence no energy consumed in standby mode. Instead of a varying number of devices in standby mode thus only a single server needs to operate permanently, which leads to corresponding energy saving.

According to a preferred embodiment of the method, before switching to shut-down mode a device transmits a command and where applicable associated data to the server, whereupon the server takes over certain standby functions from the device. Thus for example a television can arrange for the server to store transmitted program information temporarily in the network for later retrieval, a hard disk (HD) video recorder can order the downloading and temporary storage of a particular film, or a domestic appliance such as a washing machine can store on the server information retrievable for the user. The standby functions performed by the server can therefore be selected as required, depending on the situation.

In particular the server can be designed to transmit after a time delay data to and/or from a disconnected device, i.e. receive and temporarily store data for a shut-down device or temporarily store and pass on data coming from the device while the device is switched off. For example it can receive and temporarily store program information, download files, e-mail or faxes from the network when the address device is switched off and pass these data on when the device is reconnected. Conversely, it can temporarily store data such as e-mails or faxes from a device and send these with time delay to the addressee while the device itself is already switched off. In this way further cost savings can be achieved as optimized transfer times for data dispatch in the network can be utilized. Furthermore in some cases an acceleration occurs as the temporarily stored data can be retrieved more quickly from the server than from the original source.

According to a further embodiment of the method the server automatically detects and monitors connection of networks and/or active devices. The user need not therefore worry about configuring the server as this automatically detects the connected networks and devices. Continued monitoring ensures that the server always knows the current configuration. In particular it has the information on whether a particular device is active or not, so that it can automatically perform standby functions for a device in principle present in the network but currently switched off.

In addition, the server preferably tells devices newly connected to the network that it is present and which standby functions it can perform for a device. This automatic matching between server and device means that the user need not concern himself with configuration when he connects a new device to the network or reconnects a shut-down device.

The electronic devices connected to the network which can transfer standby functions to the server can for example be televisions, video recorders, set-top boxes, computers and/or domestic appliances.

The invention further relates to a server for management of availability of functions in a network of electronic devices, where the server has a central processor (CPU), a memory and at least one network interface. The server is designed to perform a method of the type described above. This means that it can perform in particular standby functions of devices when these devices are switched off. With such a server the advantages explained in connection with the method, such as energy saving by central standby operation and cheaper and faster data transmissions, can be achieved.

According to a further embodiment of the server this has an interface for data transmission to a power supply network (“power line communication”) and is designed to receive data from the power supply network and after any processing retransmit these data on at least one phase line of the power supply network. In this way a repeater function in the power line networks can be integrated in the server. Furthermore, the server may contain inputs and outputs for the connection of different transmitter and receiver modules, where the transmitter and receiver modules can communicate with the devices of the network and the server can transfer data between the transmitter and receiver modules. In this way the server can also act as a flexible and adaptable coupling module for different devices or networks with different transfer protocols, in that for each new device a suitable transmitter and receiver module is connected and the server provides the data connection between the various transmitter and receiver modules.

The invention will be further described with reference to examples of embodiment shown in the drawings, to which however the invention is not restricted. The only diagram shows a network to which the standby server according to the invention is connected.

The Figure shows as an example an in-home network in which several electronic devices such as a television 11, a video recorder 12, an HD video recorder 13, a PC 14, a washing machine 15 and other devices 16 can be connected to a databus 7, which can for example be the power line of a power line communication. Furthermore, in block 10 is indicated an Internet connection leading out of the domestic sector. If a standby function of one of the devices 11-16 is to be maintained in such a network, in the prior art said device must be operated in standby mode with a certain minimum energy consumption and cannot be shut down completely.

This disadvantage is eliminated by connecting to the network the standby server 1 according to the invention. The standby server 1 contains a central processor 3 with a local program memory, a mass memory 4 such as a hard disk or MO disk, and an interface 5 for connection to the relevant network (in the present case a powerline transceiver). The standby server 1 can also optionally contain an Internet module 2 and any further network modules 6. In order to be able to use the functions of the standby server 1, devices 11-16 merely require an additional set of functions which can usually be implemented by software.

A typical function procedure with a standby server 1 may be as follows:

On first use, the standby server 1 sends to all available networks information which tells the devices connected to the network that standby server 1 is present and active. All active devices 11-16 then report to standby server 1 and transfer to this the standby functions required by the device concerned. Thus for example television 11 can report that it understands program information to standard X and receives these from the network.

In its later operation, standby server 1 registers all network traffic. If devices are detected which it has not yet registered (for example because they have been shut down or recently added to the network), server 1 triggers an automatic enquiry to the device concerned.

If one of the devices 11-16 wishes to use the standby server 1, on shutting down it reports the shut-down procedure o the standby server 1 and where applicable gives the server commands to be performed in standby mode, e.g.:
The television 11 can state that it has been switched off and that any incoming program information should be stored,
The HD video recorder 13 can state that it has been switched off and that film X from program Y by supplier Z should be downloaded and stored. With a corresponding broadband in-home network, the standby server can itself in some circumstances perform all the functions of the HD video recorder.

The washing machine 15 can report that the washing program has ended and that the user can retrieve this information from standby server 1.

The PC 14 can report that a download of file X is to be performed at address Y, where additionally a particularly favorable time for this download can be specified.

In the standby server 1 certain functions can be programmed permanently. Thus for example for washing machine 15 a code can be provided with which the manufacturer can retrieve service information and load updated washing programs. In such a case standby server 1 first stores the behavior of the washing machine for this operation and “simulates” the behavior. The information obtained is stored.

When a previously disconnected device 11-16 which has transmitted certain standby functions to server 1 is reconnected, it announces this reconnection to the standby server 1. In continuation of the above examples, the following procedures are then performed:
The program information received in the meantime is transmitted to television 11.

The HD video recorder 13 receives the film file or where applicable only the information that the film can be replayed directly from standby server 1.

The download of file X is transferred to the PC 14.

The washing program of washing machine 15 is updated.

By the use of a central standby server 1 while fully maintaining the standby functions in the network a very low energy consumption can be achieved. Furthermore it is advantageous that the entire functionality can run completely automatically so that the user need not worry about the details or configuration. By corresponding refinement the standby server 1 can also perform additional functions such as
coupling of all existing networks to improve user-friendliness;
data storage in background mode for accelerated access;
cost reduction by optimized transmission times for data;
an increase in data rate and reliability by the implementation of a repeater function.
   Reference List
1 Standby server
2 Internet module
3 Central processor
4 Mass memory
5 Network interface
6 Network module
7 Databus
10 Internet connection
11 TV
12 Video recorder
13 HD video recorder
14 PC
15 Washing machine
16 Device

1. A method for management of availability of functions in a network of electronic devices (10-16) by a server (1) connected to the network, characterized in that functions of the devices are performed by the server when the devices are switched off.

2. A method as claimed in claim 1, characterized in that before shutting down a device (11-16) transmits a command and where applicable data to the server (1) whereupon the latter takes over certain standby functions of the device.

3. A method as claimed in claim 1 or 2, characterized in that the server (1) transmits with time delay data to and/or from a disconnected device (11-16).

4. A method as claimed in at least one of claims 1 to 3, characterized in that the server (1) automatically detects and monitors the connection of networks and/or active devices (10-16).

5. A method as claimed in at least one of claims 1 to 4, characterized in that the server (1) informs a device (10-16) newly connected to the network that it is present and which functions it can perform.

6. A method as claimed in at least one of claims 1 to 5, characterized in that the devices are televisions (11), video recorders (12, 13), set-top boxes, computers (14) and/or domestic appliances (15).

7. A server (1) for management of availability of functions in a network of electronic devices (10-16), containing a central processor (3), a memory (4) and at least one network interface (2, 5, 6), characterized in that it is designed to be able to perform standby functions of the devices when these are switched off.

8. A server as claimed in claim 7, characterized in that it is designed to perform a method as claimed in at least one of claims 1 to 6.

9. A server as claimed in claim 7 or 8, characterized in that it contains an interface for data transmission in a power supply network and is designed to receive data from the power supply network and after any processing retransmit these on at least one phase line of the power supply network.

10. A server as claimed in at least one of claims 7 to 9, characterized in that it contains inputs/outputs for connection of different transmitter and receiver modules, where the transmitter and receiver modules can communicate with devices of network and the server can transmit data between the transmitter and receiver modules.
